(19) United States
(12) Patent Application Publication
(10) Pub. No.: US 2014/0041029 A1
(43) Pub. Date: Feb. 6, 2014

(54) METHOD AND SYSTEM FOR PROCESSING WEBSITE ADDRESS RISK DETECTION

(71) Applicant: TENCENT TECHNOLOGY (SHENZHEN) COMPANY LIMITED, Guangdong (CN)

(72) Inventor: Yanying ZHOU, Guangdong (CN)

(73) Assignee: TENCENT TECHNOLOGY (SHENZHEN) COMPANY LIMITED, Guangdong (CN)

(21) Appl. No.: 14/049,002

(22) Filed: Oct. 8, 2013

Related U.S. Application Data
(63) Continuation of application No. PCT/CN2012/080419, filed on Aug. 21, 2012.

(30) Foreign Application Priority Data
Oct. 27, 2011 (CN) 201110331356.X

(51) Int. Cl. G06F 21/55

(52) U.S. Cl. CPC G06F 21/55
USPC 726/22

(57) ABSTRACT

Disclosed are a method and a device for processing URL risk detection, which belong to the field of computer technologies. The method comprises: querying a risk type of a URL for detection; querying a configuration file according to the risk type of the URL for detection, to obtain a corresponding risk level and processing policy, the configuration file including a correspondence relation between a risk type, a risk level and the processing policy; and processing the URL for detection according to the risk level and the processing policy. In the present disclosure, the risk level is determined according to the risk type of the URL for detection, and the corresponding processing policy is obtained, different types of URLs processed according to different risk levels and processing policies, so that URLs having a risk can be intercepted using diversified methods; moreover, when the risk type is determined, by matching data in a pre-created risk database, the risk type of the URL for detection is obtained without the need of binding a URL risk monitoring component, the codes are concise, and the robustness is strong.

### RELATED APPLICATIONS

This application is a continuation of PCT Application No. PCT/CN2012/080419, filed Aug. 21, 2012, which claims the benefits of Chinese Patent Application No. 201110331356.X, filed Oct. 27, 2011, the entire disclosures of which are incorporated by reference herein in their entireties for all purposes.

### TECHNICAL FIELD

The present disclosure relates to the field of computer technologies, and in one embodiment, relates to a method and a device for processing Uniform Resource Locator (URL) risk detection.

### BACKGROUND

In recent years, the computer industry has been growing rapidly. With the performance improvement and cost decrease of products such as smart phones and pad computers, the smart mobile terminals occupy more and more of the market. The smart phone and pad computer can install third-party-provided programs such as application software and games that are selected by the user himself. Of those programs, the browser is one of the most commonly installed programs. The user can surf the internet freely any time and anywhere by using a smart phone or a pad computer, attributing to the browser and the mobile communication network. In order to ensure network security for the user, the browser on the mobile terminal must perform risk detection on the URL of the webpage requested by the user.

In the existing technologies of URL risk detection, when a user accesses a URL, the browser first detects whether there is a risk in the target webpage pointed to by the URL by a bound risk-monitoring component. If there is no risk, the user's browsing operation is not disturbed, and the content of the webpage is shown to the user. If there is a risk, an interception webpage pops up to warn the user that there is a risk in the target webpage, and the browser shows the content of the webpage to the user only if the user confirms that he is going to browse it.

The inventors of the present disclosure observe that there exist, among others, the following deficiencies in the prior art when making the present disclosure:

There is only one processing method of intercepting the loading of a URL with risks. When the URL is risky, the interception webpage will pop up in any case where confirmation is needed by the user, so that the number of user's operations is increased, preventing further access. The risk detection for the URL is performed by the browser. That is, the browser in the mobile terminal is bound with a risk detection component, resulting in the corresponding program codes being long leading to a lack of expansibility.

### SUMMARY OF THE DISCLOSURE

Among other things, in order to diversify the interception manner, to reduce the number of user's operations, and to avoid too much harassment to the user, the present disclosure provides a method and a device for processing URL risk detection. The technical solutions include the following.

In one aspect, there is provided a method for processing URL risk detection, comprising processes of: querying a risk type of a URL for detection; querying a configuration file according to the risk type of the URL to obtain a risk level and a processing policy, the configuration file containing a correspondence relation between the risk type, the risk level and the processing policy; and processing the URL for detection according to the risk level and the processing policy.

In another aspect, there is also provided a device for processing URL risk detection, comprising: a query module which is configured to query a risk type of a URL for detection; a configuration module which is configured to query a configuration file according to the risk type of the URL queried by the query module to obtain a risk level and a processing policy, the configuration file containing a correspondence relation between the risk type, the risk level and the processing policy; and a processing module which is configured to process the URL for detection according to the risk level and the processing policy obtained by the configuration module.

The solutions provided by the embodiments of the present disclosure bring, among others, the following benefits.

The risk level is determined according to the risk type of the URL for detection to obtain a processing policy, and different types of URLs are processed according to different processing policies, so that the processing methods are diversified when the URLs with risks are intercepted. In addition, when the risk type is determined, by matching with data in a pre-created risk database, the risk type of the URL for detection is obtained without binding with a URL risk-monitoring component, resulting in the codes being concise and robust. Moreover, the URL and its corresponding processing policy are recorded locally, so that, when said URL is processed again, it is not necessary to determine its risk type and risk level again, but it is directly processed according to a local query result, facilitating reducing CPU load and power consumption.

The above description is only a summary of the solutions of the present disclosure. In order to better understand the technical measures of the present disclosure to implement it according to the content of the specification, and to make the above and other objects, features, and advantages of the present disclosure more easily understood, specific embodiments are described in detail in connection with the accompanying figures as follows.

### BRIEF DESCRIPTION OF THE DRAWINGS

FIG. 1 is a flowchart of a method for processing URL risk detection provided by one embodiment of the present disclosure;

FIG. 2 is a flowchart of a method for processing URL risk detection provided by another embodiment of the present disclosure;

FIG. 3 is a schematic diagram of structure of a device for processing URL risk detection provided by yet another embodiment of the present disclosure;

FIG. 4 is a schematic diagram of structure of another device for processing URL risk detection provided by yet another embodiment of the present disclosure.

### DESCRIPTION OF THE EMBODIMENTS

In order to further describe the technical measures of the present disclosure employed to obtain the predetermined inventive object and its benefits, some embodiments, structures, features, and benefits of the method and device for processing URL risk detection provided by the present disclosure are described in detail as follows.

The above and other objects, features, and benefits will be clearly presented by the following detailed description of the preferable embodiments in connection with the figures. While the technical measures of the present disclosure employed to obtain the predetermined inventive object and its benefits can be understood in depth and specifically by the description of the embodiments, the accompanying figures are provided only for reference and illustration, but not to limit the present disclosure.

As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise.

As used herein, the terms “comprising,” “including,” “having,” “containing,” “involving,” and the like are to be understood to be open-ended, i.e., to mean including, but not limited to.

As used herein, the phrase “at least one of A, B, and C” should be construed to mean a logical (A or B or C), using a non-exclusive logical OR. It should be understood that one or more steps within a method might be executed in different order (or concurrently) without altering the principles of the present disclosure.

As used herein, the term “module” may refer to, be part of, or include an Application Specific Integrated Circuit (ASIC); an electronic circuit; a combinational logic circuit; a field programmable gate array (FPGA); a processor (shared, dedicated, or group) that executes code; other suitable hardware components that provide the described functionality; or a combination of some or all of the above, such as in a system-on-chip. The term module may include memory (shared, dedicated, or group) that stores code executed by the processor.

The term “code,” as used herein, may include software, firmware, and/or microcode, and may refer to programs, routines, functions, classes, and/or objects. The term “shared,” as used herein, means that some or all code from multiple modules may be executed using a single (shared) processor. In addition, some or all code from multiple modules may be stored by a single (shared) memory. The term “group,” as used herein, means that some or all code from a single module may be executed using a group of processors. In addition, some or all code from a single module may be stored using a group of memories.

The devices and methods described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

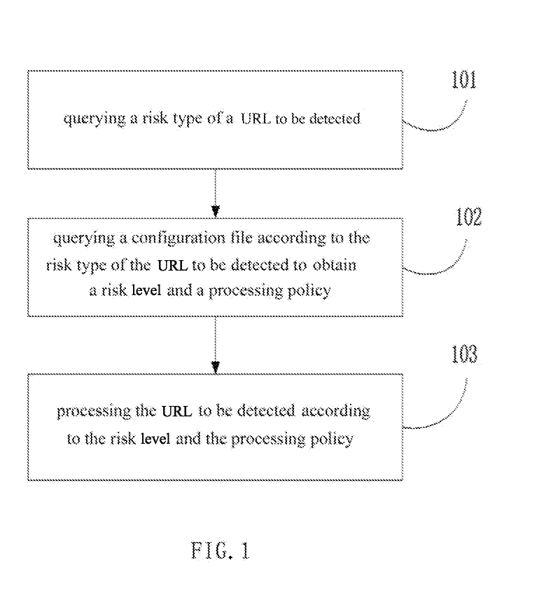

The description will be made as to the embodiments of the present invention in conjunction with the accompanying drawings in FIGS. 1-4. It should be understood that specific embodiments described herein are merely intended to explain the present invention, but not intended to limit the present invention. In accordance with the purposes of this invention, as embodied and broadly described herein, this invention, in one aspect, relates to a method and a device for processing URL risk detection.

### First Embodiment

The present embodiment provides a method for processing URL risk detection. Referring to FIG. 1, the method provided by the present embodiment is as follows.

101: querying a risk type of a URL to be detected.

In one embodiment, the present disclosure does not limit the method for querying a risk type of a URL to be detected, which includes, but is not limited to, matching the URL to be detected with data in a pre-created risk database to obtain the risk type of the URL to be detected, where a correspondence relation between the URL and the risk type is stored in the pre-created risk database.

102: querying a configuration file according to the risk type of the URL to be detected to obtain a corresponding risk level and processing policy.

Likewise, the present embodiment does not limit the risk level and its corresponding processing policy. The risk level includes, but is not limited to, four levels, which are a safety level, an unknown level, a low-risk level, and a high-risk level.

Accordingly, the processing policy corresponding to the safety level is to present a safety prompt and permit accessing the original webpage content of the URL to be detected.

The processing policy corresponding to the unknown level is to present an unknown-risk prompt and permit accessing the original webpage content of the URL to be detected.

The processing policy corresponding to the low-risk level is to pop up a prompt bar and permit accessing the original webpage content of the URL to be detected.

The processing policy corresponding to the high-risk level is to pop up a conception webpage and prevent access to the original webpage content of the URL to be detected.

It is noted that process 101 and process 102 can be performed locally, or can be performed on other devices via a network, which is not limited by the present embodiment.

103: processing the URL to be detected according to the risk level and the processing policy.

In one embodiment, since different risk levels and processing policies are obtained according to different risk types of the URLs in the above process 102, when the URL to be detected is processed, this is done according to the obtained risk level and processing policy, so that different processing methods are obtained.

In another embodiment, when the processing policy is to present a safety prompt, to present a unknown-risk prompt, or to pop up a prompt bar, and to permit accessing the original webpage content of the URL to be detected, when the URL to be detected is processed according to the risk level and the processing policy. The method provided by the present embodiment also enables the safety prompt to be presented in a fixed position, presenting the unknown-risk prompt in a fixed position, or popping up the prompt bar in a fixed position, and permitting accessing the original webpage content of the URL to be detected.

In another embodiment, when processing the URL to be detected according to the risk level and the processing policy, the method further includes displaying corresponding detailed risk information. The detailed risk information includes the risk type, the risk level, and a risk content description.

In another embodiment, after processing the URL to be detected according to the risk level and the processing policy, the method provided by the present embodiment further includes recording the URL to be detected and its corresponding processing policy locally; and accordingly directly querying the processing policy corresponding to the URL to be detected locally and processing the URL to be detected according to the query result when the URL to be detected is processed next time.

The method provided by the present embodiment has the following benefits.

The risk level is determined according to the risk type of the URL to be detected to obtain a corresponding processing policy, and different types of URLs are processed according to different processing policies, so that the processing methods are diversified when the URL with a risk is intercepted. In addition, when the risk type is determined, by matching with data in a pre-created risk database, the risk type of the URL to be detected is obtained without the need of binding a URL risk-monitoring component, resulting in the codes being concise, forceful, and robust. Moreover, the URL to be detected and its corresponding processing policy are recorded locally, so that, when said URL is processed again, it is not necessary to determine its risk type and risk level again, but it is directly processed according to a local query result, facilitating reducing CPU load and power consumption.

### Second Embodiment

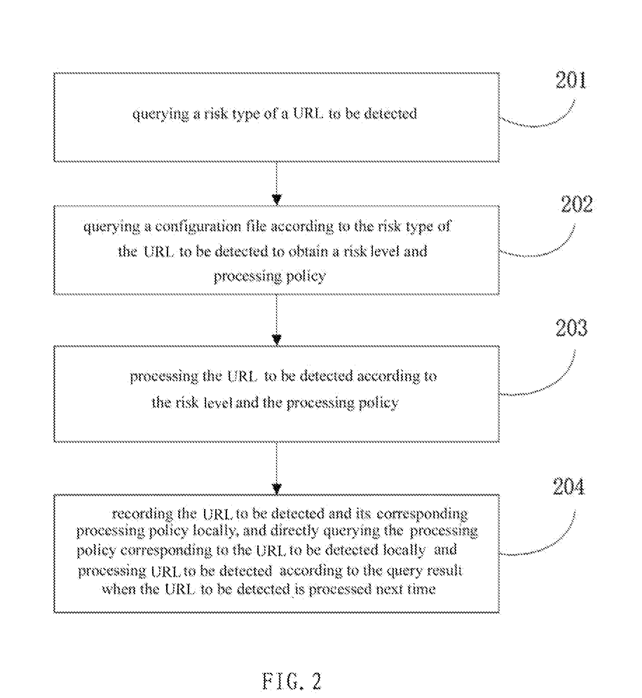

The present embodiment provides a method for processing URL risk detection, referring to FIG. 2. The method provided by the present embodiment is as follows.

201: querying a risk type of a URL to be detected.

The URL to be detected is a URL determined according to a request made by a user for browsing a webpage after the request is received. When querying the risk type of the URL to be detected, the present embodiment does not limit the method for querying the risk type of the URL, which includes, but is not limited to the following: by matching the URL to be detected with data in a pre-created risk database, the URL is detected to obtain the risk type of the URL, wherein a correspondence relation between the URL and the risk type is stored in the pre-created risk database. If no matched risk type is obtained from the risk database, that is, said URL is not recorded in the risk database, and the correspondence relation between the URL and the risk type is not found in the risk database, then the risk type of such a URL is set as an unknown risk type by default.

The risk type may include a type of malicious advertisement, a type of counterfeiting, a type of fraudulency by stealing an account, and a type of threatening the account security, etc. Other risk types may also be included. The present embodiment does not limit the risk type particularly.

In addition, the data in the risk database may be updated automatically and periodically, or updated through manual aid or the like. The present embodiment does not limit the time of the update, for example the data in the database may be updated automatically every 30 minutes, or the data may be added manually, and so on. The present embodiment does not limit data processing, including updating.

202: querying a configuration file according to the risk type of the URL to be detected to obtain a risk level and a processing policy.

For this process, the configuration file may be created in advance, including a correspondence relation between the risk type, the risk level, and the processing policy. Therefore, after the risk type of the URL to be detected is determined, when the configuration file is queried according to the risk type of the URL, the risk level and the processing policy are obtained. The present embodiment does not limit the specific form of the configuration file, neither does it limit the method of querying the configuration file. In the case that the risk type is unknown, when the configuration file is queried according to the risk type of the URL, the unknown risk type is set as an unknown-risk level by default.

The risk level includes, but is not limited to, the four levels, which can be a safety level, an unknown level, a low-risk level and a high-risk level. Each risk type corresponds to a risk level, for example, malicious advertisement corresponds to the low-risk level, and counterfeiting, fraudulency by stealing an account, and threatening account security correspond to the high-risk level. In practical application, the risk level may be further fractionized. The present embodiment does not limit specifically the types of risk level, and the correspondence between each risk type and the risk level to which it belongs, and does not limit its corresponding processing policy.

Taking the risk level including but not limited to the four levels, which are the safety level, the unknown level, the low-risk level and the high-risk level, as an example, the processing policies corresponding to the respective risk levels include the following:

The processing policy corresponding to the safety level is to present a safety prompt and permit accessing the original webpage content of the URL to be detected.

The processing policy corresponding to the unknown level is to present an unknown-risk prompt and permit accessing the original webpage content of the URL to be detected.

The processing policy corresponding to the low-risk level is to pop up a prompt bar and permit accessing the original webpage content of the URL to be detected.

The processing policy corresponding to the high-risk level is to pop up an interception webpage and prevent access to the original webpage content of the URL to be detected.

It is noted that, process 201 and process 202 may be performed locally, or may be performed on other devices via a network. For example, if the above risk database and configuration file are stored locally, then the risk type, the risk level, and the processing policy of the URL may be queried locally. As another example, in order to reduce the local storage space the above risk database and the configuration file may be stored in other devices over a network. The risk type, the risk level, and the processing policy of the URL to be detected may be queried by coupling to the other devices through the network. The present embodiment does not limit the implementation to be specifically employed.

203: processing the URL according to the risk level and the processing policy.

For this process, when the URL to be detected is processed according to the risk level and the processing policy, an exemplary process is as follows:

a) for the safety level, presenting a safety prompt to the user, and permitting accessing the original webpage content of the URL to be detected;

b) for the unknown level, presenting an unknown-risk prompt to the user, and permitting accessing the original webpage content of the URL to be detected;

c) for the low-risk level, displaying the original webpage content to the user, and popping up a prompt bar simultaneously;

d) for the high-risk level, popping up an interception webpage, and preventing the user from accessing the original webpage content.

As a solution to the above processes for the URL, for the processing methods of presenting the safety prompt, presenting the unknown-risk prompt, and popping up the prompt bar, the method provided by the present embodiment also supports presenting the safety prompt in a fixed position, presenting the unknown-risk prompt in a fixed position, or popping up the prompt bar in a fixed position. That is, the safety prompt, the unknown-risk prompt, and the prompt bar do not change their positions as the display of the webpage slides, so that the risk of it being counterfeited by a malicious URL is reduced. In addition, a method of manually screening the safety prompt, the unknown-risk prompt, or the prompt bar by the user is also supported. After the safety prompt, the unknown-risk prompt, or the prompt bar is screened, the safety prompt, the unknown-risk prompt, or the prompt bar is not displayed any more during the processing of the URL to be detected, so harassment to the user is reduced.

In addition, when the URL to be detected is processed according to the risk level and the processing policy, detailed risk information may be displayed. The present embodiment does not limit the specific content of the detailed risk information, which includes, but is not limited to, the risk type, the risk level, and a risk content description.

For example, when a URL “A” to be detected is processed, if the risk type of the URL “A” to be detected is a risk URL with the malicious advertisement of which the risk level is “low risk”, the processing policy corresponding to the low-risk level is to display the original webpage content, and pop up a prompt bar simultaneously, and the risk content description may be “the website has malicious advertisement or illegal link to seduce a risky operation”, then when the URL “A” to be detected is processed according to the risk level and the processing policy of the URL “A” to be detected, in addition to displaying the original webpage content corresponding to the URL “A” to be detected and popping up the prompt bar, its risk type, risk level, and risk content description are also presented on the webpage. The specific presentation method may be displaying on the prompt bar, or on a separate window. The present embodiment does not limit the specific presentation method.

204: recording the URL to be detected and its corresponding processing policy locally; and directly querying the processing policy corresponding to the URL to be detected locally and processing the URL to be detected according to the query result when processing the URL to be detected next time.

In one embodiment, when the URL to be detected and its corresponding processing policy are recorded locally, a black list and/or a white list may be employed. The white list stores the URLs with no risk and their corresponding processing policies, and the black list stores the URLs with risks and their corresponding processing policies, such that, when the URL to be detected is processed next time, the processing policy corresponding to the URL may be queried in the black list or the white list, and the URL is processed according to the query result.

For example, when the user opens a window to visit some webpage again, the URL of the webpage is compared with the URLs recorded in the black/white list. If the URL of the webpage is recorded in the black/white list, the webpage is processed directly according to the processing policy recorded in the black/white list. If the URL is not recorded in the black/white list, a request for the risk detection of the URL is initiated again, that is, the procedures of process 201 to process 203 are performed.

The method provided by the present embodiment has the following benefits.

The risk level is determined according to the risk type of the URL to be detected to obtain a processing policy, and different types of URLs are processed according to different processing policies, so that the processing methods are diversified when the URLs with risks are intercepted. In addition, when the risk type is determined, by matching with data in a pre-created risk database, the risk type of the URL is obtained without the need of binding a URL risk-monitoring component, resulting in the codes being concise and robust. Moreover, the URL and its corresponding processing policy are recorded locally, so that, when said URL is processed again, it is not necessary to determine its risk type and risk level again, but it is directly processed according to a local query result, facilitating reducing CPU load and power consumption.

### Third Embodiment

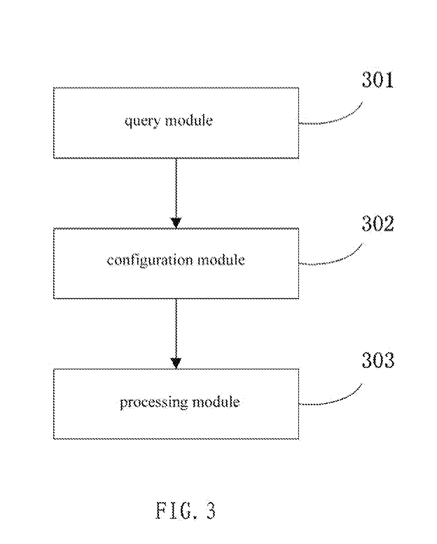

Referring to FIG. 3, the present embodiment provides a device for processing URL risk detection. The device comprises the following modules a query module 301, which is configured to query a risk type of a URL to be detected; a configuration module 302, which is configured to determine a risk level according to the risk type of the URL queried by the query module 301, and query a corresponding configuration file to obtain a processing policy, the configuration file includes a correspondence relation between the risk type, the risk level and the processing policy; and a processing module 303 which is configured to process the URL to be detected according to the risk level and the processing policy obtained in the configuration module 302.

The query module is used for matching the URL to be detected with data in a pre-created risk database, to obtain the risk type of the URL to be detected. A correspondence between the URL and the risk type is stored in the risk database built in advance.

The processing module 303 is used for presenting the safety prompt in a fixed position, presenting the unknown-risk prompt in a fixed position, or popping up the prompt bar in a fixed position, and permitting accessing the original webpage content of the URL to be detected.

In one embodiment, the processing module 303 is further used for displaying detailed risk information including the risk type, the risk level, and a risk content description.

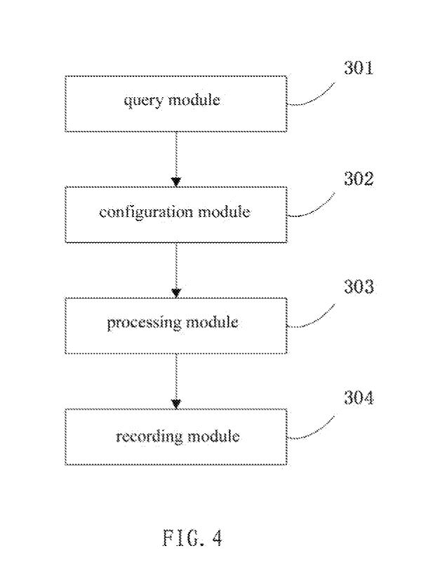

Referring to FIG. 4, the device also comprises a recording module 304, which is configured to record the URL to be detected and its corresponding processing policy locally.

The processing module 303 is further used for directly querying the processing policy corresponding to the URL to be detected locally and processing the URL according to the query result when the URL is processed next time.

The present embodiment has the following benefits.

The risk level is determined according to the risk type of the URL to be detected to obtain a processing policy, and different types of URLs are processed according to different processing policies, so that the processing methods are diversified when the URLs with risks are intercepted. In addition, when a risk type is determined, by matching with data in a pre-created risk database, the risk type of the URL to be detected is obtained without binding with a URL risk-monitoring component, resulting in the codes being concise and robust. Moreover, the URL and its corresponding processing policy are recorded locally, so that, when said URL is processed again, it is not necessary to determine its risk type and risk level again, but it is directly processed according to a local query result, facilitating reducing CPU load and power consumption.

It is noted that, when the method for processing URL risk detection provided by the above embodiment performs the process for the URL risk detection, the above individual functional modules serve only as an example. In a practical application, the above functions may be allocated to be implemented by different function modules as required. That is, the internal structures of the above functional modules may be fractionized into different functional modules to implement the above-described functions or a part thereof, or the above functional modules may be combined into one module to implement the above functions or a part thereof while saving system resources. Further, the device for processing URL risk detection and the method for processing URL risk detection provided by the above embodiments have the same technical concept. The detailed implementation of the device refers to the method embodiments, and is not described in detail herein.

It is understood by those ordinarily skilled in the art that the processes or a part thereof of the above embodiments may be implemented by hardware, or by a program instructing related hardware. The program may be stored in a computer readable storage medium, which may be read-only memory, magnetic disk, optical disk, or the like.

The above only describes embodiments of the present disclosure, and does not limit the present disclosure in any form. Although the present disclosure has been given in the form of the embodiments above, the embodiments are not used to define the present disclosure. Anyone skilled in the art can make some changes or embellishments in relation to the above-disclosed technical content as equivalent embodiments without departing from the technical scope of the present disclosure. Any simple modifications, equivalent changes, and embellishments to the above embodiments substantially according to the techniques of the present disclosure without departing from the technical solution content of the present disclosure fall into the scope of the technical solutions of the present disclosure.

### INDUSTRIAL APPLICABILITY

According to the present disclosure, the risk level is determined according to the risk type of the URL to be detected to obtain a corresponding processing policy, and different types of URLs are processed according to different processing policies, so that the processing methods are diversified when the URLs with risks are intercepted. In addition, when a risk type is determined, by matching with data in a pre-created risk database, the risk type of the URL to be detected is obtained without binding with a URL risk-monitoring component, resulting in that the codes are concise, and robust. Moreover, the URL and its corresponding processing policy are recorded locally, so that, when said URL is processed again, it is not necessary to determine its risk type and risk level again, but it is directly processed according to a local query result, facilitating reducing CPU load and power consumption.

What is claimed is:

1. A method for processing URL risk detection, comprising:
querying a risk type of a URL for detection;
querying a configuration file based on the risk type of the URL for detection to obtain a risk level and a processing policy, the configuration file including a correspondence relation among the risk type, the risk level and the processing policy; and
processing the URL for detection based on the risk level and the processing policy.

2. The method of claim 1, wherein said querying a risk type of a URL to be detected comprises: matching the URL to be detected with data in a pre-created risk database, to obtain the risk type of the URL to be detected, wherein a correspondence between the URL and the risk type is stored in the pre-created risk database.

3. The method of claim 1, wherein the risk level comprises four levels which are a safety level, an unknown level, a low-risk level and a high-risk level,
the processing policy corresponding to the safety level is to present a safety prompt and permit accessing the original webpage content of the URL to be detected;
the processing policy corresponding to the unknown level is to present an unknown-risk prompt and permit accessing the original webpage content of the URL to be detected;
the processing policy corresponding to the low-risk level is to pop up a prompt bar and permit accessing the original webpage content of the URL to be detected; and
the processing policy corresponding to the high-risk level is to pop up an interception webpage and prevent from accessing the original webpage content of the URL to be detected.

4. The method of claim 3, wherein when the processing policy is to present a safety prompt, present a unknown-risk prompt, or pop up a prompt bar, and permit accessing the original webpage content of the URL to be detected, said processing the URL to be detected according to the risk level and the processing policy comprises: presenting the safety prompt in a fixed position, presenting the unknown-risk prompt in a fixed position, or popping up the prompt bar in a fixed position, and permitting accessing the original webpage content of the URL to be detected.

5. The method of claim 1, wherein when processing the URL to be detected according to the risk level and the processing policy, further comprising: displaying a detailed risk information containing the risk type, the risk level, and a risk content description.

6. The method of claim 1, wherein after processing the URL to be detected according to the risk level and the processing policy, further comprising:
recording the URL to be detected and its processing policy locally;
directly querying the processing policy corresponding to the URL to be detected locally, and processing the URL to be detected according to the query result when the URL to be detected is processed next time.

7. A device for processing URL risk detection, comprising:
a query module configured to query a risk type of a URL for detection;
a configuration module configured to query a configuration file based on the risk type of the URL queried by the query module to obtain a risk level and processing policy, the configuration file including a correspondence relation among the risk type, the risk level and the processing policy; and
a processing module configured to process the URL for detection based on the risk level and the processing policy obtained by the configuration module.

8. The device of claim 7, wherein the query module is further configured to match the URL for detection with data in a pre-created risk database, to obtain the risk type of the URL for detection, a correspondence between the URL and the risk type is stored in the pre-created risk database.

9. The device of claim 7, wherein the processing module is further configured to present the safety prompt in a fixed position, present the unknown-risk prompt in a fixed position, or pop up the prompt bar in a fixed position, and permit accessing the original webpage content of the URL for detection.

10. The device of claim 7, wherein the processing module is further configured to display a detailed risk information containing the risk type, the risk level, and a risk content description.

11. The device of claim 7, further comprising:
a recording module configured to record the URL for detection and its processing policy locally,
wherein the processing module is further configured to directly query the processing policy corresponding to the URL for detection locally, and process the URL according to the query result when the URL for detection is processed next time.

12. A non-transitory computer-readable medium storing instructions which, when executed by one or more processors, cause a device to perform a method for processing URL risk detection, the method comprising:
querying a risk type of a URL for detection;
querying a configuration file according to the risk type of the URL for detection to obtain a risk level and a processing policy, the configuration file containing a correspondence relation among the risk type, the risk level and the processing policy; and
processing the URL for detection according to the risk level and the processing policy.

13. The non-transitory computer-readable medium of claim 12, wherein said querying a risk type of a URL for detection comprises a process of:
matching the URL for detection with data in a pre-created risk database, to obtain the risk type of the URL for detection, wherein a correspondence between the URL and the risk type is stored in the pre-created risk database.

14. The non-transitory computer-readable medium of claim 12, wherein the risk level comprises four levels which are a safety level, an unknown level, a low-risk level and a high-risk level,
the processing policy corresponding to the safety level is to present a safety prompt and permit accessing the original webpage content of the URL for detection;
the processing policy corresponding to the unknown level is to present an unknown-risk prompt and permit accessing the original webpage content of the URL for detection;
the processing policy corresponding to the low-risk level is to pop up a prompt bar and permit accessing the original webpage content of the URL for detection;
the processing policy corresponding to the high-risk level is to pop up a interception webpage and prevent from accessing the original webpage content of the URL for detection.

15. The non-transitory computer-readable medium of claim 14, wherein when the processing policy is to present a safety prompt, present a unknown-risk prompt, or pop up a prompt bar, and permit accessing the original webpage content of the URL for detection, said processing the URL for detection according to the risk level and the processing policy comprises a process of:
presenting the safety prompt in a fixed position, presenting the unknown-risk prompt in a fixed position, or popping up the prompt bar in a fixed position, and permitting accessing the original webpage content of the URL for detection.

16. The non-transitory computer-readable medium of claim 12, wherein when processing the URL for detection according to the risk level and the processing policy, further comprising a process of:
displaying a detailed risk information containing the risk type, the risk level, and a risk content description.

17. The non-transitory computer-readable medium of claim 12, wherein after processing the URL for detection according to the risk level and the processing policy, further comprising a process of:
recording the URL for detection and its processing policy locally;
directly querying the processing policy corresponding to the URL for detection locally, and processing the URL for detection according to the query result when the URL for detection is processed next time.
